(19) United States
(12) Patent Application Publication
(10) Pub. No.: US 2015/0304526 A1
(43) Pub. Date: Oct. 22, 2015

(54) EXTERNAL VIDEO LOCKING AND SYNCHRONIZATION DEVICE

(71) Applicant: ClearOne, Inc., Salt Lake City, UT (US)

(72) Inventors: Oren J. Maurice, Yoqneam Moshava (IL); Avishay Ben Natan, Hod Hasharon (IL)

(21) Appl. No.: 14/616,664

(22) Filed: Feb. 7, 2015

Related U.S. Application Data
(60) Provisional application No. 61/937,500, filed on Feb. 8, 2014.

(51) Int. Cl. H04N 5/06; H04N 5/44

(52) U.S. Cl. CPC H04N 5/06; H04N 5/44

(57) ABSTRACT

This disclosure describes an external video locking and synchronization device (104) in communication with a video source (102) and a target device (106). The external video locking and synchronization device (104) provides a video receiver (202), a memory (208), and a locking and synchronization circuitry (204). The video receiver (202) receives a video signal from the video source (102). The video signal has one or more video frames, each being associated with clocking information and frame synchronization information. The memory (208) is in communication with the video receiver (202) and stores the clocking information and the frame synchronization information. The locking and synchronization circuitry (204) adjusts vertical frequency of the video signal by a predetermined value; and generates a synchronized video signal for the target device (106), where the synchronized video signal is locked into the video signal.

### CROSS REFERENCE TO RELATED APPLICATIONS

This application claims priority and the benefits of the earlier filed Provisional USAN 61/937,500, filed 8 Feb. 2014, which is incorporated by reference for all purposes into this specification.

### TECHNICAL FIELD

This disclosure relates to video synchronization. More specifically, this disclosure relates to an external video locking and synchronization device.

### BACKGROUND ART

High definition (HD) video streaming is gradually replacing standard definition video streaming to satisfy needs of continually upgrading or newer video coding standards via compatible interfaces such as High Definition Multimedia Interface (HDMI). The current video streaming system can automatically choose the most suitable video/audio format and can simultaneously transmit HD video signals and multi-channeled audio signals using a smaller connector that is easier to use and reduces usage of conductive lines. HD video signals from an HDMI source (e.g., Blu-ray disc players, set-top boxes, camcorders, mobile devices, and so on) are often synchronized with display characteristics (e.g., aspect ratio, supported resolution, timing parameters, refresh rate, etc.) of an intended target device using display or video cards.

The display cards are cost intensive and are typically embedded or integrated with each target device, thereby increasing the installation, maintenance, and overall cost of the target device. Moreover, display cards suffer from digital artifacts causing video frames to inevitably drop between the HDMI source and the target device. Such frame drops can increase the frame rendering time as sensed by a target device, thereby decreasing the received frame rate, to cause “stuttering” of smoothly moving objects in the video stream, e.g., on tiled displays of the multi-participant videos on the target device during a video conferencing session. As a result, user experience and viewing comfort is significantly diminished.

Therefore there exists a need for an economical frame synchronization solution that can be applied without modifying both the video source and target device electronics or any related hardware.

### SUMMARY OF INVENTION

This disclosure describes an external video locking and synchronization device.

One embodiment of the present disclosure includes an external video locking and synchronization device in communication with a video source and a target device. The external video locking and synchronization device comprises a video receiver, a memory, and a locking and synchronization circuitry. The video receiver receives a video signal from said video source. Said video signal comprises one or more video frames, each being associated with clocking information and frame synchronization information. The memory is in communication with said video receiver and stores said clocking information and said frame synchronization information. Said locking and synchronization circuitry may be configured to adjust vertical frequency of said video signal by a predetermined value; and generate a synchronized video signal for said target device, wherein said synchronized video signal is locked into said video signal.

Another embodiment of present disclosure includes a method to make an external video locking and synchronization device in communication with a video source and a target device. The method comprises providing a video receiver receiving a video signal from said video source, wherein said video signal comprises one or more video frames, each being associated with a clocking information and a frame synchronization information; providing a memory in communication with said video receiver, wherein said memory stores said clocking information and said frame synchronization information; and providing a locking and synchronization circuitry, configured to adjust vertical frequency of said video signal by a predetermined value, and generate a synchronized video signal for said target device, wherein said synchronized video signal is locked into said video signal.

Yet another embodiment of the present disclosure includes a method to use an external video locking and synchronization device in communication with a video source and a target device. The method comprises receiving a video signal using a video receiver from said video source, wherein said video signal comprises one or more video frames, each being associated with clocking information and frame synchronization information; storing said clocking information and said frame synchronization information using a memory, where said memory is in communication with said video receiver; adjusting vertical frequency of said video signal by a predetermined value using a locking and synchronization circuitry; and generating a synchronized video signal for said target device using said locking and synchronization circuitry, wherein said synchronized video signal is locked into said video signal.

Still another embodiment of the present disclosure includes a non-transitory program storage device readable by a computing device that tangibly embodies a program of instructions executable by said computing device to perform a method to use an external video locking and synchronization device in communication with a video source and a target device. The method comprises receiving a video signal using a video receiver from said video source, wherein said video signal comprises one or more video frames, each being associated with clocking information and frame synchronization information; storing said clocking information and said frame synchronization information using a memory, where said memory is in communication with said video receiver; adjusting vertical frequency of said video signal by a predetermined value using a locking and synchronization circuitry; and generating a synchronized video signal for said target device using said locking and synchronization circuitry, wherein said synchronized video signal is locked into said video signal.

Other and further aspects and features of the disclosure will be evident from reading the following detailed description of the embodiments, which are intended to illustrate, not limit, the present disclosure.

### BRIEF DESCRIPTION OF DRAWINGS

To further aid in understanding the disclosure, the attached drawings help illustrate specific features of the disclosure and the following is a brief description of the attached drawings:

FIG. 1 illustrates a network environment implementing an exemplary video locking and synchronization device, in accordance with an embodiment of the present disclosure.

FIG. 2 illustrates the exemplary video locking and synchronization device of FIG. 1, in accordance with an embodiment of the present disclosure.

FIG. 3A illustrates the operation of the video locking and synchronization device of FIG. 1 when a target frame rate is longer than a remote video source frame rate, in accordance with an embodiment of the present disclosure.

FIG. 3B illustrates the operation of the video locking and synchronization device of FIG. 1 when the target frame rate is shorter than the remote video source frame rate, in accordance with an embodiment of the present disclosure.

### DISCLOSURE OF EMBODIMENTS

This disclosure describes a video locking and synchronization device. This disclosure describes numerous specific details in order to provide a thorough understanding of the present invention. One ordinarily skilled in the art will appreciate that one may practice the present invention without these specific details. Additionally, this disclosure does not describe some well-known items in detail in order not to obscure the present invention.

Non-Limiting Definitions

In various embodiments of the present disclosure, definitions of one or more terms that will be used in the document are provided below.

A “Video Source” is used in the present disclosure in the context of its broadest definition. The video source may refer to one or more computing devices capable of establishing a communication channel for providing digital video signals in a communication session. Examples of the computing devices may comprise, but are not limited to, a desktop PC, a personal digital assistant (PDA), a server, a mainframe computer, a mobile computing device (e.g., mobile phones, laptops, tablets, etc.), an internet appliance (e.g., gateway, router, set-top box, video digital signage player, etc.), and calling devices (e.g., an internet phone, video telephone, etc.). The video source may be based on or run a variety of operating system platforms such as Microsoft Windows, Linux, Android, and so on.

A “Target Device” is used in the present disclosure in the context of its broadest definition. The target device may refer to a variety of computing devices, such as those mentioned above, being integrated or associated with one or more video display appliances including, but not limited to, monitors and projectors.

A “Frame Rate” is used in the present disclosure in the context of its broadest definition. The frame rate may refer to the number of video frames outputted per second. The frame rate may be expressed in Hertz (Hz).

A “Refresh Rate” is used in the present disclosure in the context of its broadest definition. The refresh rate may refer to the number of times in a second that a display appliance updates its screen with a video frame. The refresh rate may be expressed in Hertz (Hz).

A “Vertical Frequency” is used in the present disclosure in the context of its broadest definition. The vertical frequency may refer to the number of times per second at which each pixel of a video frame is drawn from top to bottom on a display screen. The vertical frequency may be expressed in Hertz (Hz).

A “Horizontal Frequency” is used in the present disclosure in the context of its broadest definition. The horizontal frequency may refer to the number of times per second at which a single line of pixels of a video frame is drawn from left to right on a display screen. The horizontal frequency may be expressed in Hertz (Hz).

A “Master Clock” is used in the present disclosure in the context of its broadest definition. The master clock may refer to the clock of a video source that is distributed among all connected devices. The master clock may be expressed in 100 microsecond accuracy.

A “Frame Latency” is used in the present disclosure in the context of its broadest definition. The frame latency may refer to the time delay between a video frame being sent by one device and received by another.

A “Slice Time” is used in the present disclosure in the context of its broadest definition. The slice time may refer to the time duration elapsed between a video slice of a video frame being sent by one device and received by another.

A “Horizontal Front Porch” is used in the present disclosure in the context of its broadest definition. The horizontal front porch may refer to the right border of a display screen.

A “Horizontal Back Porch” is used in the present disclosure in the context of its broadest definition. The horizontal back porch may refer to the left border of a display screen.

A “Vertical Back Porch” is used in the present disclosure in the context of its broadest definition. The vertical back porch may refer to the top border of a display screen.

A “Vertical Front Porch” is used in the present disclosure in the context of its broadest definition. The vertical front porch may refer to the bottom border of a display screen.

The numerous references in the disclosure to the external video locking and synchronization device are intended to cover any and/or all devices capable of performing respective operations on the target device in a conferencing environment relevant to the applicable context, regardless of whether or not the same are specifically provided.

Embodiments are disclosed in the context of a video conferencing environment among one or more users via respective endpoints capable of receiving or rendering video signals comprising one or more video frames or images. Other embodiments may be applied in the context of other scenarios (e.g., television broadcast, video surveillance, online gameplay, etc.) involving display of video signals from one or more video sources. Such embodiments may include an external video locking and synchronization device that inputs video signals from a video source and outputs adjusted video signals to a target device. In some embodiments, the adjusted video signals may have the average vertical frequency being locked into the vertical frequency at which input video signals may be received by the external video locking and synchronization device.

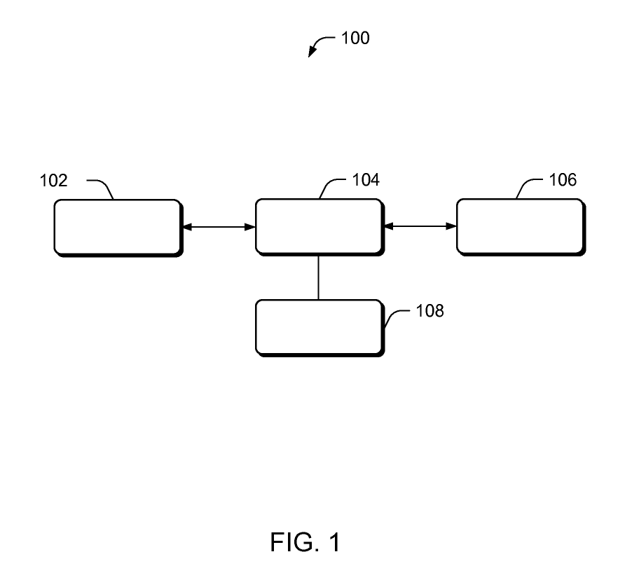

FIG. 1 illustrates a network environment implementing an exemplary video locking and synchronization device, in accordance with an embodiment of the present disclosure. The network environment 100 may comprise one or more video sources such as a video source 102, an external video locking and synchronization device 104, and a target device 106. Examples of the video source 102 may include a video player (e.g., a Blu-ray disc player), an imaging device (e.g., camera, camcorders, etc.), a video decoder (e.g., a digital signage player, a set-top box, a television, etc.), a desktop personal computer (PC), a mobile computing device (e.g., a personal digital assistant (PDA), a notebook, a laptop, a tablet, a mobile phone, etc.), a video calling device (e.g., a video phone, an internet phone, etc.), or any other device, component, object or network system having any combination of similar devices capable of rendering video signals encoded in any of a variety of known, related art, or later developed video codec standards including H.264, H.265, MPEG1, MPEG2, and HDMI.

The video source 102 may comprise or be coupled with one or more hardware devices either wirelessly or in a wired fashion for enabling a user to dynamically interact with the video source 102 or the external video locking and synchronization device 104. In one embodiment, the video source 102 may be coupled to an imaging device (not shown) such as a video camera and a webcam, an audio device (not shown) such as a speaker and a microphone, one or more input devices (not shown) such as a keyboard, a digital pen, and the like, or any combination thereof. In another embodiment, the video source 102 may be operatively connected to any other compatible devices (not shown) to receive at least video signals or provide video signals, or both, to the external video locking and synchronization device 104.

The external video locking and synchronization device 104 may interface between the video source 102 and the target device 106. The video source 102 may communicate with the target device 106 via the video locking and synchronization device 104 based on a predefined video transmission standard. In some embodiments, the video source 102 may transmit video signals, such as HDMI video signals, to the target device 106 via the external video locking and synchronization device 104 based on HDMI standard using a suitable wireless link or a wired link such as HDMI cables. In other words, the video source 102 may behave as an HDMI source.

In one embodiment, the external video locking and synchronization device 104 may render the video source 102 compliant to the display capabilities, such as the required resolution and HDMI timing parameters, of the target device 106 based on extended display identification data (EDID) received from the target device 106. EDID may enable the video source 102 to determine the type of display appliance connected directly or indirectly to the video source 102 via the external video locking and synchronization device 104. EDID may include a variety of information including, but not limited to, manufacturer name and serial number, product type, phosphor or filter type, timings supported by the display appliance, display size, luminance data and (for digital displays only) pixel mapping data. In one embodiment, the video source 102 may dynamically use the EDID to preset or update the vertical frequency, e.g., 60 Hz, at which it outputs video signals. Accordingly, the video source 102 retrieves the refresh rate or nominal frame rate from the EDID for one or more display appliances (e.g., display monitor, projector, etc.) operatively coupled to the target device 106 and presets its output frame rate. In another embodiment, the master clock frequency, e.g., 60 Hz, of the video source 102 may be preset based on the implemented video communication standard, such as HDMI standard. As such, the target device 106 may behave as an HDMI target device 106 to receive the video signals from the video source 102 via the external video locking and synchronization device 104.

The external video locking and synchronization device 104 may represent any of a wide variety of devices capable of providing video locking and synchronization services to the network devices. The external video locking and synchronization device 104 may be implemented as a standalone and dedicated device including hardware and installed software, where the hardware is closely matched to the requirements and/or functionality of the software. Alternatively, the external video locking and synchronization device 104 may be implemented as a software application or a device driver on existing hardware devices such as a multipoint control unit (not shown). The external video locking and synchronization device 104 may enhance or increase the functionality and/or capacity of the network to which it is connected. In one embodiment, the external video locking and synchronization device 104 may perform tasks, such as, e-mail tasks, security tasks, network management tasks including IP address management, and the likes. In another embodiment, the external video locking and synchronization device 104 may expose its computing environment or operating code to a user, and may include related art I/O devices, such as a keyboard or display. The external video locking and synchronization device 104 of some embodiments may, however, include software, firmware, or other resources that support remote administration and/or maintenance of the external video locking and synchronization device 104.

In some embodiments, the external video locking and synchronization device 104 either in communication with any of the networked devices such as the video source, or independently, may have video, voice, and data communication capabilities (e.g., unified communication capabilities) by being coupled to or including, various imaging devices (e.g., cameras, printers, scanners, medical imaging systems, etc.), various audio devices (e.g., microphones, music players, recorders, audio input devices, speakers, audio output devices, telephones, speaker telephones, etc.), various video devices (e.g., monitors, projectors, displays, televisions, video output devices, video input devices, camcorders, etc.), or any other type of hardware, in any combination thereof. In some embodiments, the external video locking and synchronization device 104 may comprise or implement one or more real time protocols (e.g., session initiation protocol (SIP), H.261, H.263, H.264, H.323, etc.) and non-real time protocols known in the art, related art, or developed later to facilitate communication of video signals between the video source 102 and the target device 106, or any other network devices.

In some other embodiments, the external video locking and synchronization device 104 may be configured to convert communications, which may include instructions, queries, data, etc., from the video source 102 into appropriate formats to make these communications compatible with the target device 106, and vice versa. Consequently, the external video locking and synchronization device 104 may allow implementation of the video source 102 to employ different technologies or services using a proprietary technology managed by different organizations, e.g., a third-party vendor.

The video source 102 may be modified to further include a timing data. The timing data is included such that the video source being modify can synchronize the video frames across one or more adjacent displays and avoid video shuttering. In one embodiment, the video source 102 may use the EDID received from the external video locking and synchronization device 104 to dynamically increase its vertical frequency by a predetermined value to become relatively greater than the refresh rate of the target device's display appliance(s). For example, the video source 102 may increase the vertical frequency by 1000 parts per million (PPM) to output the video signals at an adjusted vertical frequency of (nominal frame rate+1000 Hz), e.g., (60 Hz+1000 PPM), i.e., 60.06 Hz. Such an increase in the vertical frequency enhances the capacity of a video signal to carry video frames and prevents frame drops between the video source 102 and the external video locking and synchronization device 104.

The video source 102 may be further modified to include duplicate frames or slices. The video source may be modified to include duplicate frames or slices in order to synchronize the video frames across one or more adjacent displays and to avoid video stuttering. In one embodiment, the video source 102 may be preconfigured or dynamically configured by the external video locking and synchronization device 104 to append additional information to each video frame of the generated video signals for a reliable frame transfer to the target device 106 via the external video locking and synchronization device 104. In one embodiment, the video source 102 may associate each video frame with a Current Master Clock Time (i.e., clocking information) and a Frame Presentation Time (i.e., frame control information), each having 64-bit values. The current master clock time may refer to a time stamp of the master clock of the video source 102 at which a video frame is generated by the video source. The frame presentation time (FPT) may refer to a time stamp at which a video frame is sent to the external video locking and synchronization device 104. The frame presentation time may be expressed in units same as the master clock, e.g., in microseconds. The FPT value may be used to ensure receipt of a correct video frame by analyzing a received video frame at the target device 106 for determining that each pair of values for consecutive video frames are spaced relatively equal in time, e.g., at a time spacing of 17 millisecond (ms) for the vertical frequency of 60 Hz, and that no video frame is received twice.

The current master clock time (i.e., clocking information) and frame presentation time may be subtly embedded in each video frame by using any of the techniques known in the art, related art, or developed later. For example, a 24-bit bitmap video frame has 8 bits for representing each of the three color values (red, green, and blue) at each pixel. For the blue alone, there will be 256 different levels of blue intensity. In one instance, the difference between 11111111 and 11111110 in the value for blue intensity may go undetected by the human eye. Therefore, the least significant bit and/ or few adjacent bits may be used to embed the current master clock time and the frame presentation time, rather than color information, in each video frame.

Based on the adjusted vertical frequency, e.g., 60.06 Hz, for the video signals, the video source 102 may output video frames at an output frame rate (nominal frame rate, e.g., 60 frames per second (FPS), +1000 PPM), which may be higher than the master clock frequency, e.g., 60 Hz, of the video source. However, in case no new video frame is available to be displayed, the output frame rate of the video source 102 may get relatively lower than the master clock frequency. In case of such frame starvation, the video source 102 may be configured to output the last video frame again such that each repeated video frame may have the same FPT as the previous frame but different current master clock time.

In another embodiment, the current master clock time and the FPT may be added as an additional slice at the beginning or end of a video frame based on a relatively higher master clock frequency. By way of example, the current master clock time and the FPT may be added as the additional slice, which may comprise of one or more pixels, at the beginning or end of the video frame, when the master clock frequency is greater than 60 Hz, which exists in case of HDMI standard. Because frame latency cannot be less than the slice time, the video source 102 may set the slice time to be one-tenth of a FPT or lower to reduce frame latency.

In such slice approach, each set number of display pixel lines in a video frame may be preceded by an additional slice representing clocking and control information (hereinafter referred to as a control line), or the control line may be embedded in a predetermined place in a slice (e.g., the first line), in a subtle way as discussed above. Multiple slices can be sent from the video source 102 device in any order for display, e.g., using raster scan. This allows for the infrequent duplicate (or missing) data to be slice-sized, rather than full frame-sized, to significantly reduce the frame latency and the size of memory required. In one embodiment, the frame latency may be reduced by minimum of 50%. In another embodiment, the frame latency may be reduced to 17 ms or lower. In some embodiments, the control line may be removed by a transmitter 206, discussed later, of the external video locking and synchronization device 104 before the video frames or corresponding video signals are displayed on a display appliance operatively in communication with the target device 106.

The external video locking and synchronization device 104 may be powered by, in one embodiment, an external power supply unit 108, such as an external battery or a controlled AC supply that provides sufficient voltage to run the external video locking and synchronization device 104. In another embodiment, the external video locking and synchronization device 104 may be electrically connected to at least one of the video source 102 or the target device 106 via a suitable wired link (such as via a USB cable) or wireless link to draw power for operation in the network environment 100.

In some embodiments, the external video locking and synchronization device 104 may be connected as a peripheral device to either of the video source 102 or the target device 106. In further embodiments, the external video locking and synchronization device 104 may be operatively connected or integrated with any network appliance (not shown) configured to establish a network between the video source 102 and the target device 106. At least one of the external video locking and synchronization device 104 and the network appliance may be capable of operating as or providing an interface to assist exchange of software instructions and video signals between the video source 102 and the target device 106. In some embodiments, the network appliance may be preconfigured or dynamically configured to include or control the external video locking and synchronization device 104 integrated with other devices. For example, the external video locking and synchronization device 104 may be integrated with the video source 102 or any other endpoint (not shown) connected to the network.

The video source 102 may comprise a module (not shown), which may enable the external video locking and synchronization device 104 being introduced to the network appliance, thereby enabling the network appliance to invoke or control the external video locking and synchronization device 104 as a service. Examples of the network appliance may include, but are not limited to, a DSL modem, a wireless access point, a set-top box (STB), a router, a base station, and a gateway having a predetermined computing power sufficient for implementing the external video locking and synchronization device 104. In yet another embodiment, the video source 102 may interact with a server (not shown) over the network. The server may be integrated, or operatively associated with the external video locking and synchronization device 104. The server may be implemented as any of a variety of computing devices including, for example, a general purpose computing device, multiple networked servers (arranged in clusters or as a server farm), a mainframe, or so forth.

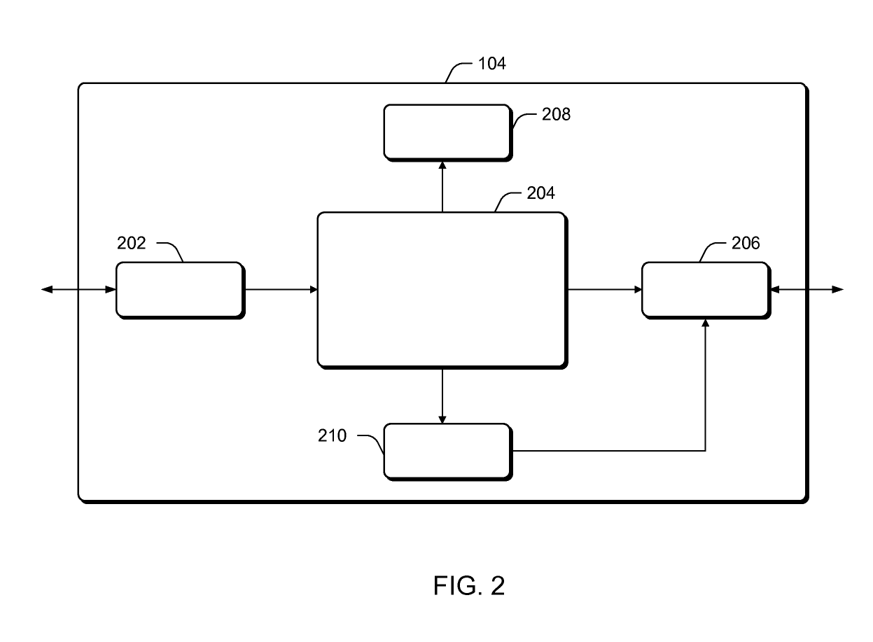

FIG. 2 illustrates the exemplary video locking and synchronization device 104 of FIG. 1, in accordance with an embodiment of the present disclosure. The external video locking and synchronization device 104 may be implemented as a single physical device (e.g., a computing device, a processor or an electronic storage device) or a combination of multiple physical devices that are operatively connected or networked together. The external video locking and synchronization device 104 may be implemented in hardware or a suitable combination of hardware and software. In some embodiments, the external video locking and synchronization device 104 may be a hardware device including processor(s) (not shown) executing machine readable software instructions for handling video signals received from the video source. The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors. The processor(s) may include, for example, microprocessors, microcomputers, microcontrollers, digital signal processors, central processing units, state machines, logic circuits, and/or any devices that manipulate signals based on operational instructions. Among other capabilities, the processor(s) may be configured to fetch and execute computer readable instructions in a memory associated with the external video locking and synchronization device 104 for performing tasks such as signal transcoding, data processing, input/output processing, power control, and/or other functions.

In some embodiments, the external video locking and synchronization device 104 may include, in whole or in part, a software application working alone or in conjunction with one or more hardware resources. Such software applications may be executed by the processor(s) on different hardware platforms or emulated in a virtual environment. Aspects of the external video locking and synchronization device 104 may leverage known, related art, or later developed off-the-shelf software. Other embodiments may comprise the external video locking and synchronization device 104 being integrated or in communication with a mobile switching center, network gateway system, Internet access node, application server, IMS core, service node, or some other communication systems, including any combination thereof. In some embodiments, the external video locking and synchronization device 104 may be integrated with or implemented as a wearable device including, but not limited to, a fashion accessory (e.g., a wrist band, a ring, etc.), a utility device (a hand-held baton, a pen, an umbrella, a watch, etc.), a body clothing, or any combination thereof.

The external video locking and synchronization device 104 may include a variety of known, related art, or later developed interface(s) (not shown), including software interfaces (e.g., an application programming interface, a graphical user interface, etc.); hardware interfaces (e.g., cable connectors, a keyboard, a card reader, a barcode reader, a biometric scanner, an interactive display screen, etc.); or both.

The external video locking and synchronization device 104 may further comprise a video receiver 202, a locking and synchronization circuitry 204, a transmitter 206, a system memory 208, and a clock circuitry 210 including a voltage controlled oscillator. The system memory 208 may store (1) uncompressed video data, timing information (e.g., vertical frequency, horizontal frequency, blanking period, frame rate, etc.), and current timing of each frame (e.g., current master clock time, frame presentation time, etc.); (2) a log of profiles of connected devices and associated communications including instructions, queries, conversations, data, and related metadata; and (3) EDID retrieved by the locking and synchronization circuitry 204 from the target device 106 or any other networked device.

The system memory 208 may comprise of any computer-readable medium known in the art, related art, or developed later including, for example, a processor or multiple processors operatively connected together, volatile memory (e.g., RAM), non-volatile memory (e.g., flash, etc.), disk drive, etc., or any combination thereof. In some embodiments, the system memory 208 may include one or more databases, which may be sub-divided into further databases for storing electronic files. The system memory 208 may have one of many database schemas known in the art, related art, or developed later for storing video data received from the video sources or the video signals. For example, a database may have a relational database schema involving a primary key attribute and one or more secondary attributes. In some embodiments, the external video locking and synchronization device 104 may perform one or more operations, but not limited to, reading, writing, indexing, encoding, decoding, manipulating and updating the video signals, and may communicate with various networked computing devices such as the target device 106.

The video receiver 202 may receive and handle the video frames of the video signals in any predefined media format known in the art, related art, or developed later received from the video source. The video receiver 202 sends the video frames in the received video signals to the locking and synchronization circuitry 204 for further processing.

The locking and synchronization circuitry 204 may be implemented as a field programmable gate array (FPGA), an erasable programmable logic device (EPLD), a system on a chip (SOC), or any other type of device known in the art, related art, or developed later. The locking and synchronization circuitry 204 may be configured to examine each received video frame for the clocking and the frame synchronization information. In one example, the locking and synchronization circuitry 204 may examine first or last pixel line of each video frame for the embedded current master clock time and the frame presentation time. The locking and synchronization circuitry 204 may update and synchronize a local clock of the external video locking and synchronization device 104 to the current master clock time in the system memory 208. In other words, the locking and synchronization circuitry 204 uses receipt of the clocking information as an adjustment point and corrects its own master clock, or the local clock, for being synchronized with the global system current master clock associated with the video source 102. Since the frequency at which such clocking information is received with each frame (i.e., update frequency) may be very high, e.g., 16 ms, corresponding to the adjusted vertical frequency, e.g., 60.06 Hz, of the video source 102, the master clock of the external video locking and synchronization device 104 is not locked to the master clock of the video source 102.

Further, the locking and synchronization circuitry 204 may compare the FPT of the current video frame with that of the last received video frame. Upon comparison, if the current FPT is equal to the last FPT, the locking and synchronization circuitry 204 determines that a video frame may be dropped while being sent from the video source 102 to the external video locking and synchronization device 104 and therefore may either request for or wait until the lost video frame is received from the video source 102.

On the other hand, if the locking and synchronization circuitry 204 determines that the current FPT is not equal to the FPT of the last received video frame, the new video frame may be pushed into the system memory 208 in a First-In-First-Out (FIFO) format and the last FPT is updated in the system memory 208 for comparing it with the FPT of the next received video frame, and so on. Once all video frames (no drops) are transferred to the device 104, each video frame may be transferred to the transmitter 206, which may send the video frames to the target device 106 based on any video transmission technique known in the art, related art, or developed later.

When the transmitter 206 receives a video frame from the system memory 208 by the locking and synchronization circuitry 204, the transmitter 206 begins to transmit the video frame to the target device 106. In case the transmitter 206 has no new video frame to send for display on the target device 106, the previous video frame may be re-sent and a video frame may be doubled on the target device 106. In a properly functional external video loading device, such doubling of video frames may occur only at the system start-up and may be displayed as fillers (e.g., bars, logo, etc.) on the display appliance of the target device 106.

In one embodiment, when the transmitter 206 is operational, the locking and synchronization circuitry 204 may compare the FPT of a video frame with the current master clock time, which is associated with the video frame and is updated in the system memory 208. If the FPT has exceeded the current master clock time and the time gap between the FPT and the current master clock time has not decreased below a predetermined threshold value since the last video frame, the clock circuitry 210 may be activated by the locking and synchronization circuitry 204 to increase the vertical frequency by a predetermined value, e.g., 50 PPMs.

However, if the FPT is in the future or is lesser than the current master clock time in the system memory 208 for the video frame, and the time gap between the FPT and the clock time has not decreased below a predetermined threshold value since the last received video frame, the locking and synchronization circuitry 204 determines that the output frame rate is very fast and manipulates the clock circuitry 210 to decrease the vertical frequency by a predetermined threshold value, e.g., 50 PPMs.

In order to change the vertical frequency, the clock input to the transmitter 206 may be changed using the external clock circuitry 210. The magnitude of change required in the clock input to the transmitter 206 may depend on the time gap between the FPT and the current master clock time for each video frame. The greater the time gap, the larger the change implemented to modify the clock input to the transmitter 206.

In some embodiments, parameters such as horizontal porch, vertical porch, front porch, and back porch related to the display appliance of the target device 106 may define the display timing of the transmitter 206. These parameters may be changed in the transmitter 206 using a suitable communication standard such as 120 access cable to synchronize the frame rate of the transmitter 206 with the refresh rate of the display appliance of the target device 106.

Alternatively, the locking and synchronization circuitry 204 may modify the vertical or horizontal blanking period for reducing and eventually eliminating the time gap between the FPT and the current master clock time for each video frame. Decreasing the blanking period may increase the output frame rate and increasing the blanking period may decrease the output frame rate to the transmitter 206.

The value of the time gap may get smaller as the difference between the successive clocks gets smaller such that, video signals having the dynamically adjusted vertical frequency or vertical synchronous signal received across all target devices, such as the target device 106, may converge and become relatively identical over time, because all the target devices receive the same master clock of the video source 102. This is very effective when same video signals are required to be synchronized across multiple display appliances such as screens, monitors, and projectors.

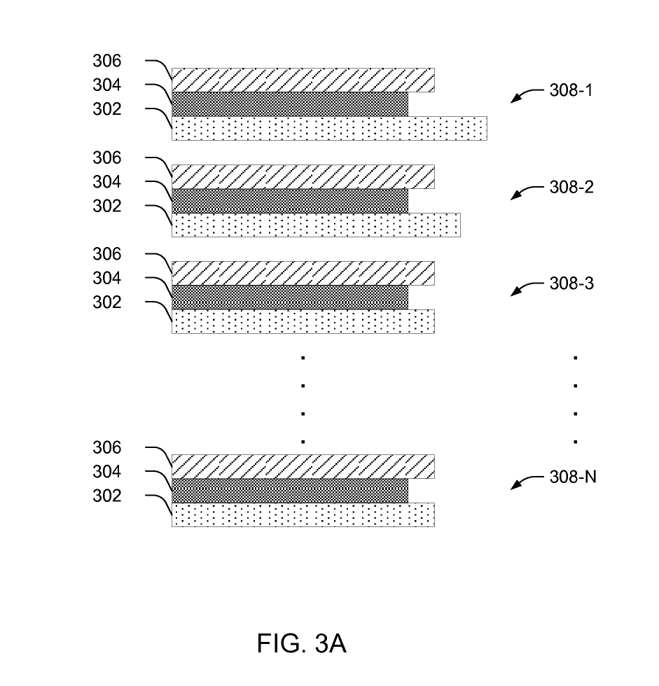

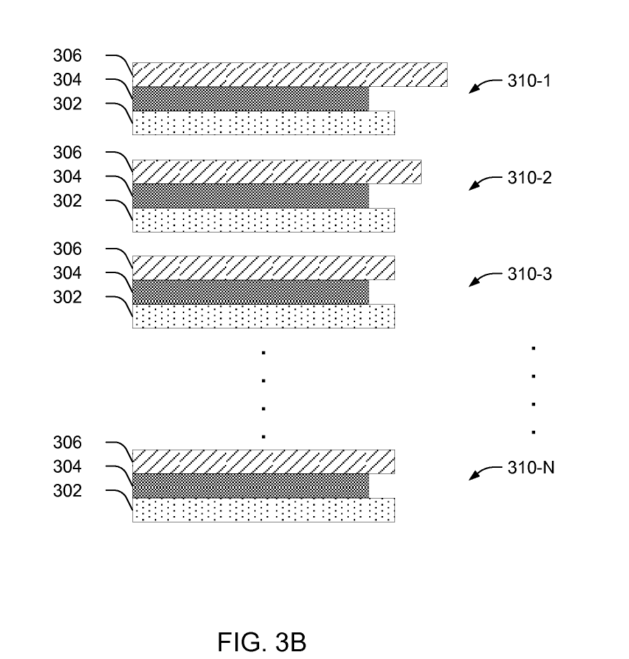

FIG. 3A illustrates the operation of the external video locking and synchronization device 104 of FIG. 1 when a target frame rate is longer than a remote video source frame rate, in accordance with an embodiment of the present disclosure. FIG. 3A shows a target frame rate 302 (TFR 302), a video source frame rate 304 (VSFR 304), and a remote video source frame rate 306 (RSFR 306). At an event 308-1, the TFR 302 may be longer than the VSFR 304, which is relatively shorter than the TFR 302 and RSFR 306. All video frames at this event 308-1 may be transferred from a remote video source (not shown) to the video source 102. Since the incoming frame rate from the remote source, i.e., RSFR 306, is lesser than the TFR 302, the video source 102 may starve to send new video frames to the target device 106. In such a scenario, the external video locking and synchronization device 104 decreases the vertical frequency to adjust the frame rate, i.e., TFR 302, at the target device 106. Hence, over the period of time for events 308-2, 308-3, . . . 308-N, the TFR 302 is continuously corrected by the external video locking and synchronization device 104 to stay around the RSFR 306 so that the difference between the average RSFR 306 and the average TFR 302 converges to zero as shown at the event 308-N.

FIG. 3B illustrates the operation of the external video locking and synchronization device 104 of FIG. 1 when the target frame rate is shorter than the remote video source frame rate, in accordance with an embodiment of the present disclosure. FIG. 3B also shows the target frame rate 302 (TFR 302), a video source frame rate 304 (VSFR 304), and a remote video source frame rate 306 (RSFR 306). At an event 310-1, the TFR 302 may be shorter than the VSFR 304, which is relatively shorter than the TFR 302 and RSFR 306. All video frames at this event 310-1 may be transferred from a remote video source (not shown) to the video source 102. Since the incoming frame rate from the remote source, i.e., RSFR 306, is greater than the TFR 302, the video source 102 may send more video frames to the display appliance of the target device 106, such that the display appliance may suffer from the problem of screen tear or offsetting of frame portions due mismatch in the incoming frame rate and the actual frame rate at the target device 106. In such a scenario, the external video locking and synchronization device 104 may decrease the vertical frequency to adjust the incoming frame rate, i.e., RSFR 306, via the video source 102. Hence, over the period of time for events 310-2, 310-3, . . . 310-N, the TFR 302 is continuously corrected by the external video locking and synchronization device 104 to stay around the RSFR 306 so that the difference between the average RSFR 306 and the average TFR 302 converges to zero as shown at the event 310-N.

In some embodiments, the deviation of the vertical frequency or VSynch signals across multiple external video locking devices using the same Master Clock of the video source 102 may be in the range of 20-30 μSec, which is around 1-2 promille of frame time, 16.6 milliseconds for 60 Hz in case of HDMI standard. However, all such VSynch signals across various external video locking and synchronization devices may converge to relatively the same time.

The external video locking and synchronization device 104 may be designed and configured to support on-the-fly changes of the target device 106 having different frame rate and resolution. The external video locking and synchronization device 104 may be configured to reset when a change of EDID values of the target device 106 is detected and accordingly update the EDID values stored in the system memory 208 and relay the updated EDID values to the video source 102.

Unlike the traditional solution, the external video locking and synchronization device 104 may utilize the global master clock and the master clock time of the video source 102, as well as the frame presentation time for adjusting the output frame rate at which video frames are received by the target device 106. Additionally, the clock control mechanism, which is implemented at the transmitter 206, may be internal to the external video locking and synchronization device 104 in contrast to the conventional solutions.

Further, since the external video locking and synchronization device 104 operates with predictable video signals based on predetermined adjustment to the vertical frequency using the embedded clocking and control information in each video frame, the operational gap between various operating frequencies such as vertical frequency and horizontal frequency can be much tighter. Hence, the external video locking and synchronization device 104 is suitable for frame accurate synchronization among displays when multiple decoders/players compose a large view on multiple displays. Unlike virtually various solutions known in the art, the external video locking and synchronization device 104 ensures that the high motion objects in the video stream/content do not ‘break’ between adjacent displays and frame synchronization is good for stereoscopic display or a video wall.

Hence, the external video locking and synchronization device 104 along with the video source 102 being modified (1) to include the timing data (e.g., adjusted vertical frequency based on EDID of the target device), (2) to support duplicate frames or slices (e.g., using embedded clocking and control information in each video frame), and (3) to enable output of slices in any order (e.g., using raster scan), collectively ensure frame synchronization and avoid video stuttering for smooth display of video frames on one or more display appliances simultaneously.

To summarize, one embodiment of the present disclosure includes an external video locking and synchronization device in communication with a video source and a target device. The external video locking and synchronization device comprises a video receiver, a memory, and a locking and synchronization circuitry. The video receiver receives a video signal from said video source. Said video signal comprises one or more video frames, each being associated with clocking information and frame synchronization information. The memory is in communication with said video receiver and stores said clocking information and said frame synchronization information. Said locking and synchronization circuitry may be configured to adjust vertical frequency of said video signal by a predetermined value; and generate a synchronized video signal for said target device, wherein said synchronized video signal is locked into said video signal.

Another embodiment of present disclosure includes a method to make an external video locking and synchronization device in communication with a video source and a target device. The method comprises providing a video receiver receiving a video signal from said video source, wherein said video signal comprises one or more video frames, each being associated with a clocking information and a frame synchronization information; providing a memory in communication with said video receiver, wherein said memory stores said clocking information and said frame synchronization information; and providing a locking and synchronization circuitry, configured to adjust vertical frequency of said video signal by a predetermined value, and generate a synchronized video signal for said target device, wherein said synchronized video signal is locked into said video signal.

Yet another embodiment of the present disclosure includes a method to use an external video locking and synchronization device in communication with a video source and a target device. The method comprises receiving a video signal using a video receiver from said video source, wherein said video signal comprises one or more video frames, each being associated with clocking information and frame synchronization information; storing said clocking information and said frame synchronization information using a memory, where said memory is in communication with said video receiver; adjusting vertical frequency of said video signal by a predetermined value using a locking and synchronization circuitry; and generating a synchronized video signal for said target device using said locking and synchronization circuitry, wherein said synchronized video signal is locked into said video signal.

Still another embodiment of the present disclosure includes a non-transitory program storage device readable by a computing device that tangibly embodies a program of instructions executable by said computing device to perform a method to use an external video locking and synchronization device in communication with a video source and a target device. The method comprises receiving a video signal using a video receiver from said video source, wherein said video signal comprises one or more video frames, each being associated with clocking information and frame synchronization information; storing said clocking information and said frame synchronization information using a memory, where said memory is in communication with said video receiver; adjusting vertical frequency of said video signal by a predetermined value using a locking and synchronization circuitry; and generating a synchronized video signal for said target device using said locking and synchronization circuitry, wherein said synchronized video signal is locked into said video signal.

Other embodiments of the present invention will be apparent to those ordinarily skilled in the art after considering this disclosure or practicing the disclosed invention. The specification and examples above are exemplary only, with the true scope of the present invention being determined by the following claims.

I/we claim the following invention:

1. An external video locking and synchronization device for video signals where the device is in communication with a video source and a target device, comprising:
a video receiver that receives the video signal from the video source, wherein the video signal comprises one or more video frames, each being associated with a clocking information and a frame synchronization information;
a memory in communication with said video receiver, wherein said memory stores said clocking information and said frame synchronization information; and
a locking and synchronization circuitry, configured to:
adjust vertical frequency of the video signal by a predetermined value; and
generate a synchronized video signal for the target device, wherein said synchronized video signal is locked into the video signal.

2. The claim according to claim 1, further comprising a transmitter receiving said synchronized video signal for transmission to said target device at a predetermined frame rate.

3. The claim according to claim 2, further comprising a clock circuitry generating a clock signal to adjust said vertical frequency of said synchronized video signal based on said clocking information and said frame synchronization information associated with each video frame.

4. The claim according to claim 1, wherein said locking and synchronization circuitry is at least one of a field programmable gate array, an erasable programmable logic device, and a system-on-a-chip.

5. The claim according to claim 1, wherein the video signal is a high definition multimedia interface (HDMI) signal.

6. A method to make an external video locking and synchronization device for video signals where the device is in communication with a video source and a target device, comprising:
providing a video receiver that receives the video signal from the video source, wherein the video signal comprises one or more video frames, each being associated with a clocking information and a frame synchronization information;
providing a memory in communication with said video receiver, wherein said memory stores said clocking information and said frame synchronization information; and
providing a locking and synchronization circuitry, configured to:
adjust vertical frequency of the video signal by a predetermined value; and
generate a synchronized video signal for the target device, wherein said synchronized video signal is locked into the video signal.

7. The claim according to claim 6, further comprising the step of providing a transmitter for receiving said synchronized video signal for transmission to said target device at a predetermined frame rate.

8. The claim according to claim 7, further comprising the step of providing a clock circuitry for generating a clock signal to adjust said vertical frequency of said synchronized video signal based on said clocking information and said frame synchronization information associated with each video frame.

9. The claim according to claim 6, wherein said locking and synchronization circuitry is at least one of a field programmable gate array, an erasable programmable logic device, and a system-on-a-chip.

10. The claim according to claim 6, wherein the video signal is a high definition multimedia interface (HDMI) signal.

11. A method to use an external video locking and synchronization device for video signals where the device is in communication with a video source and a target device, comprising:
receiving the video signal with a video receiver from the video source, wherein the video signal comprises one or more video frames, each being associated with clocking information and frame synchronization information;
storing said clocking information and said frame synchronization information with a memory, said memory being in communication with said video receiver;
adjusting vertical frequency of the video signal by a predetermined value with a locking and synchronization circuitry; and
generating a synchronized video signal for the target device with said locking and synchronization circuitry, wherein said synchronized video signal is locked into the video signal.

12. The claim according to claim 11, further comprising the step of receiving said synchronized video signal with a transmitter for transmission to said target device at a predetermined frame rate.

13. The claim according to claim 12, further comprising the step of generating a clock signal with a clock circuitry to adjust said vertical frequency of said synchronized video signal based on said clocking information and said frame synchronization information associated with each video frame.

14. The claim according to claim 11, wherein said locking and synchronization circuitry is at least one of a field programmable gate array, an erasable programmable logic device, and a system-on-a-chip.

15. The claim according to claim 11, wherein the video signal is a high definition multimedia interface (HDMI) signal.

16. A non-transitory program storage device readable by a computing device that tangibly embodies a program of instructions executable by said computing device to perform a method to use an external video locking and synchronization device for video signals where the device is in communication with a video source and a target device, comprising:
receiving the video signal with a video receiver from the video source, wherein the video signal comprises one or more video frames, each being associated with clocking information and frame synchronization information;
storing said clocking information and said frame synchronization information with a memory, said memory being in communication with said video receiver;
adjusting vertical frequency of the video signal by a predetermined value with a locking and synchronization circuitry; and
generating a synchronized video signal for the target device with said locking and synchronization circuitry, wherein said synchronized video signal is locked into the video signal.

17. The claim according to claim 16, further comprising the step of receiving said synchronized video signal with a transmitter for transmission to said target device at a predetermined frame rate.

18. The claim according to claim 17, further comprising the step of generating a clock signal with a clock circuitry to adjust said vertical frequency of said synchronized video signal based on said clocking information and said frame synchronization information associated with each video frame.

19. The claim according to claim 16, wherein said locking and synchronization circuitry is at least one of a field programmable gate array, an erasable programmable logic device, and a system-on-a-chip.

20. The claim according to claim 16, wherein the video signal is a high definition multimedia interface (HDMI) signal.
